(19) United States
(12) Patent Application Publication
(10) Pub. No.: US 2015/0001119 A1
(43) Pub. Date: Jan. 1, 2015

(54) CONNECTING DEVICE AND STACKABLE STORAGE UNIT WITH THE SAME

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: MAN-ZHONG WANG, Shenzhen (CN)

(21) Appl. No.: 14/312,988

(22) Filed: Jun. 24, 2014

(30) Foreign Application Priority Data
Jun. 27, 2013 (CN) 2013102617618

(51) Int. Cl. B25B 5/08; B65D 21/02; B25B 5/10

(52) U.S. Cl. CPC B25B 5/08; B25B 5/10; B65D 21/0205
USPC 206/503; 269/229; 269/236; 269/240

(57) ABSTRACT

A connecting device includes an activator, a linkage mechanism, a cam, a guide, a locking bar, a torsion spring, and a spring element. The activator is rotatably connected to a first stackable storage unit. The linkage mechanism is rotatably connected to the activator. The cam is rotatably connected to the linkage mechanism. The guide defines a guiding groove. The locking bar passes through the guide and stays in contact with the cam. The locking bar includes a locking block and a rib. The rib protrudes from the lateral surface of the locking bar. The rib is slidably received in the guiding groove. The torsion spring is pivoted on the locking bar. The spring element exerts a force to the locking bar.

### CROSS-REFERENCE TO RELATED APPLICATIONS

This application claims priority to Chinese Patent Application No. 201310261761.8 filed on Jun. 27, 2013 in the China Intellectual Property Office, the contents of which are incorporated by reference herein.

### FIELD

The subject matter herein generally relates to connecting devices, and particularly, to a connecting device capable of connecting two stackable storage units.

### BACKGROUND

In a workshop, some stackable storage units need to be stacked together to be transported to a different position.

### BRIEF DESCRIPTION OF THE DRAWINGS

Implementations of the present technology will now be described, by way of example only, with reference to the attached figures.

FIG. 1 illustrates of an embodiment of a first stackable storage unit and a second stackable storage unit stacked on the first stackable storage unit.

FIG. 2 is an enlarged view of the circled portion II of FIG. 1, and omitting a portion of the second stackable storage unit.

FIG. 3 is similar to FIG. 1, but showing the first stackable storage unit 100 and a second stackable storage unit separated from the first stackable storage unit.

FIG. 4 is an enlarged view of the circled portion IV of FIG. 3.

FIG. 5 illustrates of an embodiment of a connecting device, and shows the connecting device in a first state.

FIG. 6 is an enlarged view of the circled portion VI of FIG. 5.

FIG. 7 is similar to FIG. 5, but showing the connecting device in a second state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Embodiments of the present disclosure will be described with reference to the accompanying drawings.

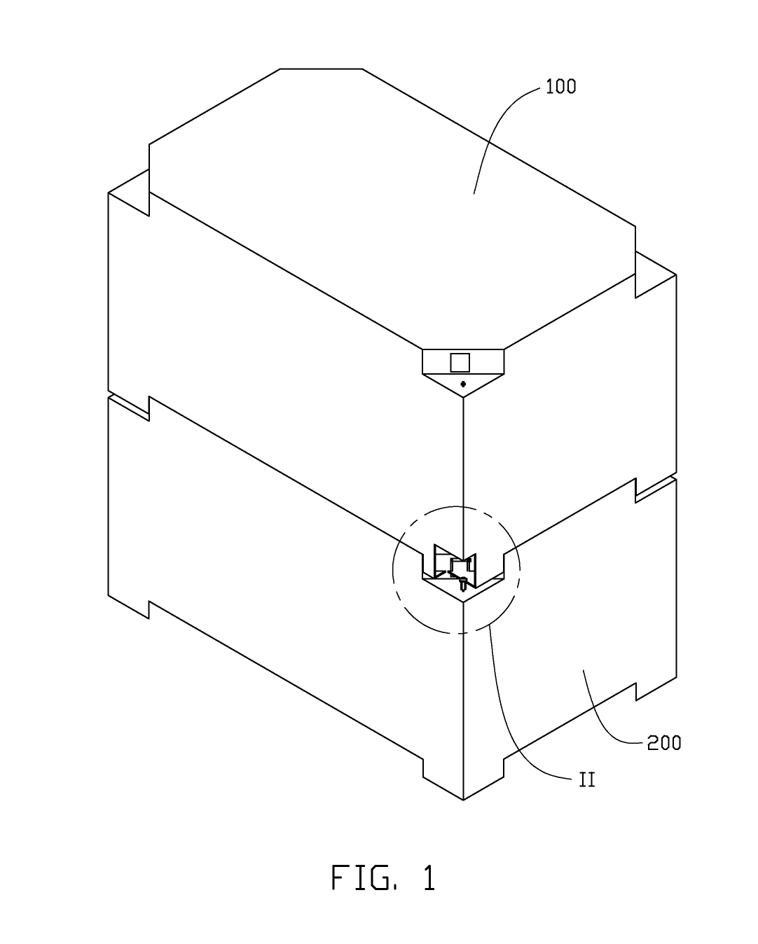

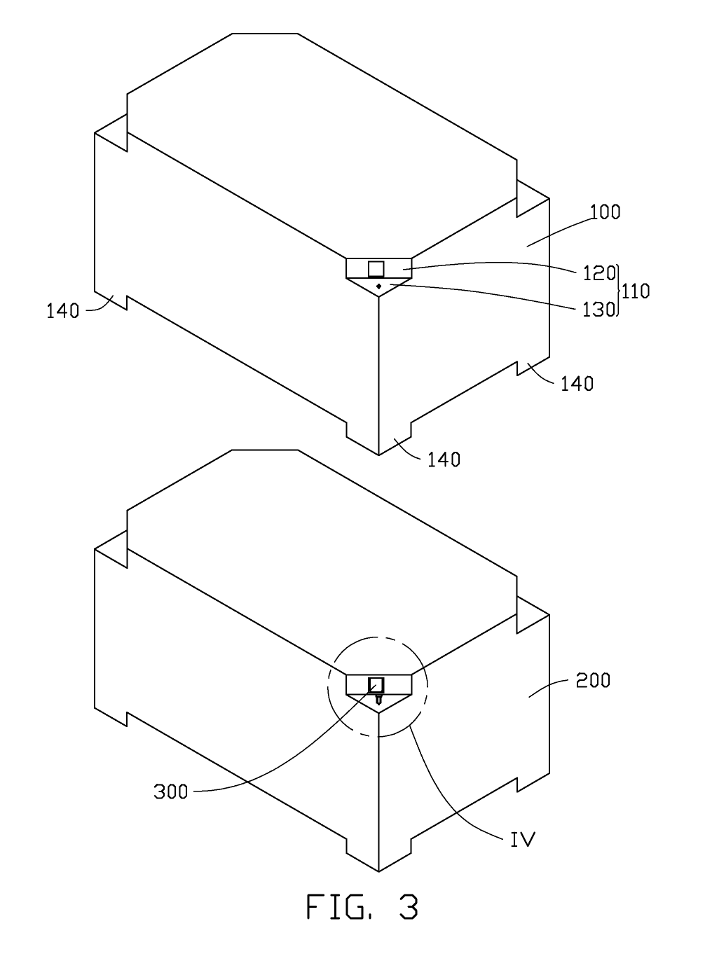

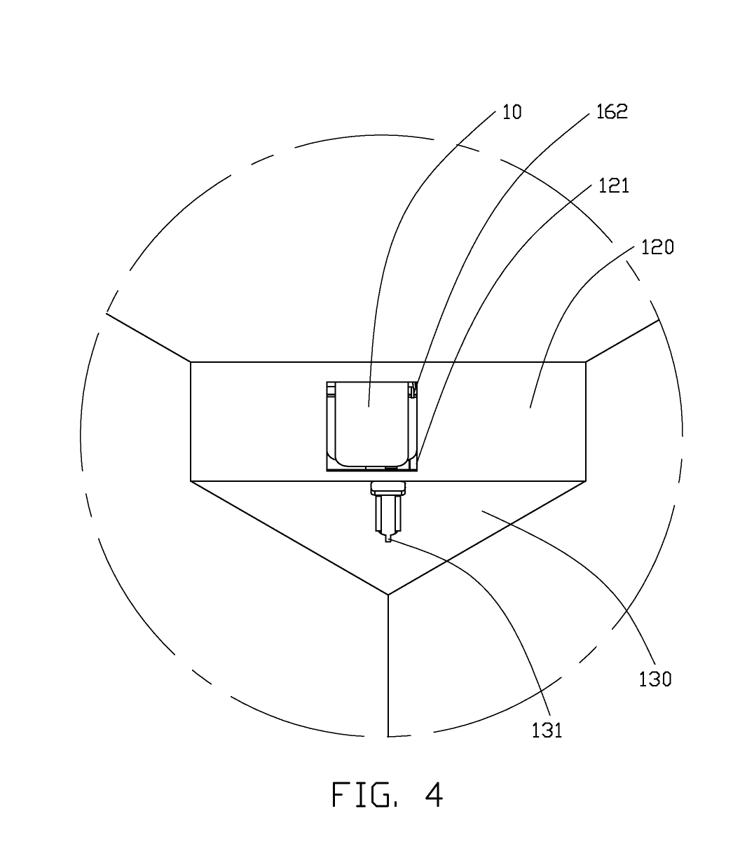

FIGS. 1-3 illustrate a first stackable storage unit 100 and a second stackable storage unit 200 stacked on the first stackable storage unit 100. The first stackable storage unit 100 and the second stackable storage unit 200 have the same structure. For simplicity, the first stackable storage unit 100 will be described below in detail, it is understood that the structure of the second stackable storage unit 200 is analogous with the first stackable storage unit 100. The first stackable storage unit 100 is a substantially rectangular prism. The first stackable storage unit 100 defines four first gaps 110, each of which is formed at one of four corners of a top of the first stackable storage unit 100. Each first gap 110 can include a vertical surface 120 and a horizontal surface 130. The vertical surface 120 defines a first through hole 121 (see FIG. 4). The horizontal surface 130 defines a second through hole 131. The first stackable storage unit 100 can include four supports 140 corresponding to the four first gaps 110. Each support 140 is arranged on one corner of a bottom of the first stackable storage unit 100. Each support 140 of the second stackable storage unit 200 can mate with the corresponding first gap 110 of the first stackable storage unit 100. When the second stackable storage unit 200 is stacked on the first stackable storage unit 100, each support 140 of the second stackable storage unit 200 is received in the corresponding first gap 110 of the first stackable storage unit 100.

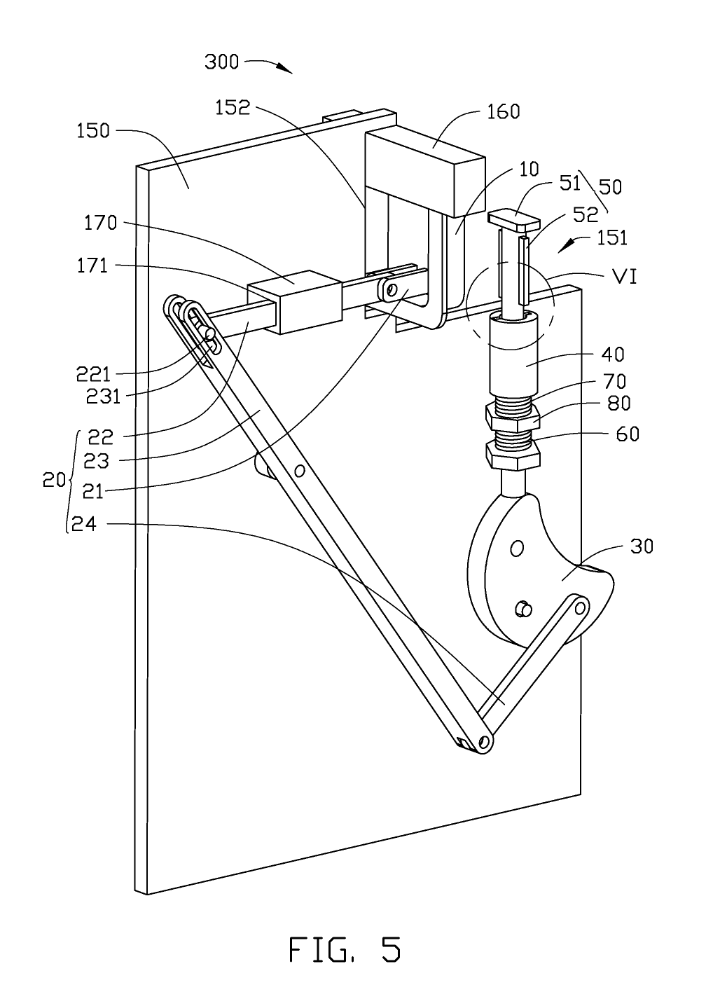

FIGS. 4-5 illustrate that the first stackable storage unit 100 can further include a plurality of connecting devices 300. For simplicity, one connecting device 300 will be described in detail below. It is understood that the connecting devices 300 included in the first stackable storage unit 100 are mutually analogous. When the second stackable storage unit 200 is stacked on the first stackable storage unit 100, the connecting device 300 can be triggered to connect the second stackable storage unit 200 to the first stackable storage unit 100.

The first stackable storage unit 100 can include an outer casing 150. The connecting device 300 is connected to the outer casing 150. The connecting device 300 can include an activator 10, a linkage mechanism 20, a cam 30, a guide 40, a locking bar 50, a torsion spring 60, a spring element 70, and a nut 80.

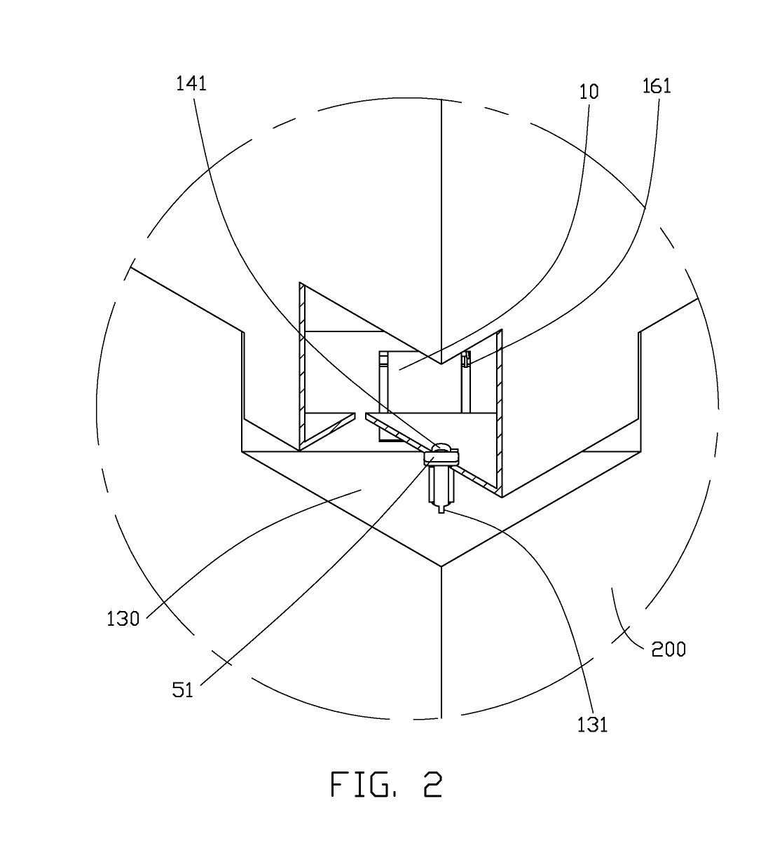

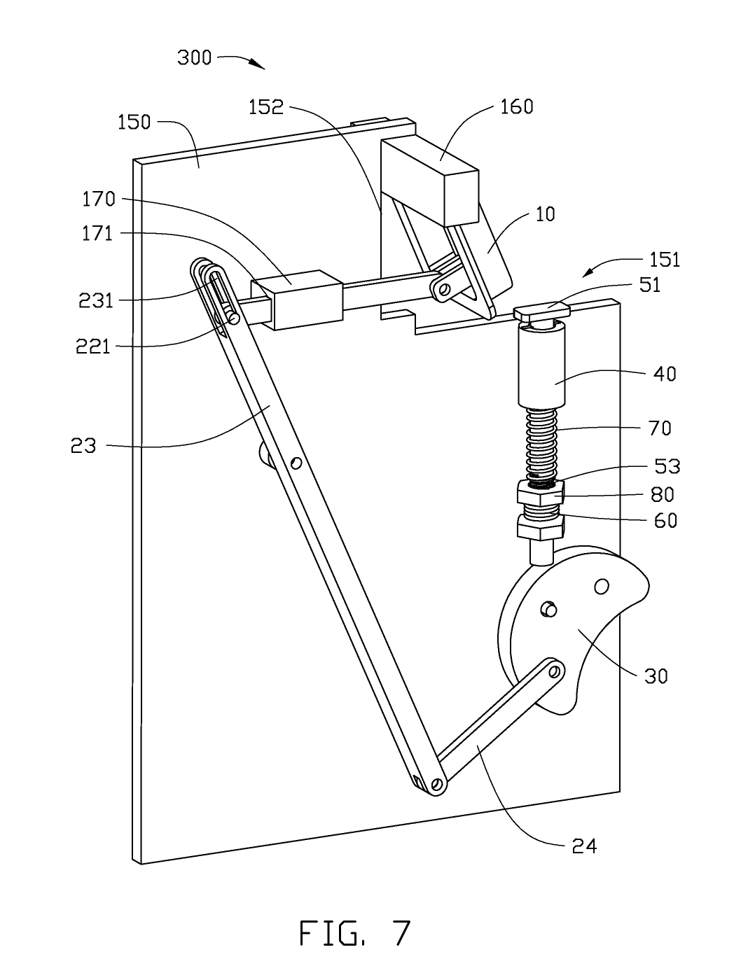

One end of the activator 10 is rotatably connected to the outer casing 150. In the embodiment, the outer casing 150 defines a second gap 151. The second gap 151 can include a vertical surface 152. In the embodiment, the first stackable storage unit 100 can further include a beam 160. The beam 160 is attached to the top of the vertical surface 152 of the second gap 151. The beam 160 is substantially perpendicular to the outer casing 150. The top of the activator 10 is rotatably connected to the beam 160, thus the activator 10 can rotate between a first position (see FIG. 7) and a second position (see FIG. 5). In the embodiment, the activator 10 is rotatably connected to the beam 160 through a shaft 161 (see FIG. 2). When the activator 10 is at the first position, the activator 10 can be exterior to the first through hole 121, and inclined to the vertical surface 120 of the first gap 110. When the activator 10 is at the second position, the activator 10 can be received in the first through hole 121, and the surface of the activator 10 is substantially parallel with the vertical surface 120 of the first gap 110. In the embodiment, a spring 162 is pivoted on the shaft 161 and is arranged between the activator 10 and the beam 160. A first end of the spring 162 is connected to the activator 10, and a second end of the spring 162 is connected to the beam 160. The spring 162 can exert a force to the activator 10 to retain the activator 10 at the first position when no external force is exerted on the activator 10.

A first end of the linkage mechanism 20 is rotatably connected to the bottom of the activator 10. A second end of the linkage mechanism 20 is rotatably connected to the cam 30. When the activator 10 is pushed to rotate from the first position to the second position, the linkage mechanism 20 can be pushed by the activator 10 to drive the cam 30 to rotate. In the embodiment, the linkage mechanism 20 can include a first connecting rod 21, a second connecting rod 22, a third connecting rod 23, and a fourth connecting rod 24.

A first end of the first connecting rod 21 is connected to a bottom of the activator 10, and a second end of the first connecting rod 21 is connected to the second connecting rod 22.

In the embodiment, the first stackable storage unit 100 can further include a guiding member 170. The guiding member 170 is attached to the outer casing 150. The guiding member 170 defines a guiding hole 171. The second connecting rod 22 passes through the guiding hole 171, and the second connecting rod 22 can be slidably connected to the outer casing 150. A first end of the second connecting rod 22 is connected to the second end of the first connecting rod 21. The second end of the second connecting rod 22 includes a sliding pin 221. The second end of the second connecting rod 22 is connected to the third connecting rod 23 through the sliding pin 221.

A top end of the third connecting rod 23 defines a sliding groove 231. The sliding pin 221 is received in the sliding groove 231. The sliding pin 221 can slide along the sliding groove 231 and rotate in the sliding groove 231. The third connecting rod 23 is rotatably connected to the outer casing 150 by a pin passing through a substantially middle portion of the third connecting rod 23 and is fixed in the outer casing 150. A bottom end of the third connecting rod 23 is rotatably connected to the fourth connecting rod 24. The third connecting rod 23 can be pushed by the second connecting rod 22 and the fourth connecting rod 24 to rotate relative to the outer casing 150.

In the embodiment, the fourth connecting rod 24 is rotatably connected to the outer casing 150 by a pin passing through a substantially middle portion of the fourth connecting rod 24 and is fixed in the outer casing 150. A bottom end of the fourth connecting rod 24 is connected to the third connecting rod 23, and a top end of the fourth connecting rod 24 is rotatably connected to the cam 30. The fourth connecting rod 24 can be pushed by the third connecting rod 23 and the cam 30 to rotate relative to the outer casing 150.

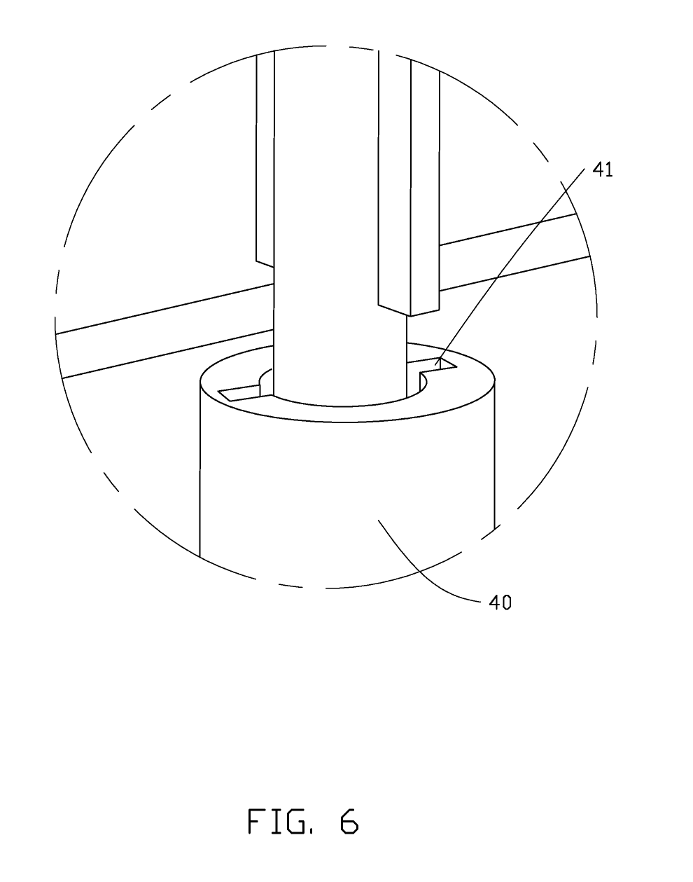

The cam 30 is rotatably connected to the outer casing 150 and arranged below the locking bar 50. A bottom end of the cam 30 is rotatably connected to the fourth connecting rod 24. The guide 40 is attached to the outer casing 150. The guide 40 further defines at least one guiding groove 41 (see FIG. 6) from an upper portion of the guide 40 to a lower portion of the guide 40. In the embodiment, two guiding grooves 41 are employed.

The locking bar 50 can pass from the upper portion of the guide 40 to the lower portion of the guide 40, and stay in contact with the circumferential surface of the cam 30. A top of the locking bar 50 can include a locking block 51. In the embodiment, the bottom of each support 140 defines an opening 141. The shape of the locking block 51 is the same as the shape of the opening 141 (see FIG. 2) and the size of the locking block 51 is the same as the size of the opening 141. The locking block 51 is exterior to the second through hole 131 and can pass through the opening 141. The locking bar 50 can further include at least one rib 52. In the embodiment, two ribs 52 are employed. Each rib 52 protrudes from the lateral surface of the locking bar 50 and extends along the longitude of the locking bar 50. Each rib 52 can be received in one corresponding guiding groove 41 and can slide along the corresponding guiding groove 41.

The torsion spring 60 is pivoted on the locking bar 50. A first arm of the torsion spring 60 is attached to the locking bar 50. A second arm of the torsion spring 60 abuts against the outer casing 150. The torsion spring 60 can exert a torsion torque to the locking bar 50. Thus, the locking bar 50 whose position is shown as FIG. 7 can rotate 90 degrees after each rib 52 slides out of the corresponding guiding groove 41, and the position of the rotated locking bar 50 is shown as FIG. 5. Namely, the torsion spring 60 is elastically deformed in FIG. 7, and after each rib 52 slides out of the corresponding guiding groove 41, the torsion spring 60 can rebound to rotate the locking bar 50 substantially 90 degrees.

In the embodiment, the spring element 70 is a coil spring. The spring element 70 is pivoted on the locking bar 50. The top end of the spring element 70 abuts against the bottom of the guide 40. In the embodiment, the locking bar 50 can further include a thread member 53. The nut 80 is threadedly connected to the thread member 53. The bottom end of the spring element 70 abuts against the nut 80.

When connecting the second stackable storage unit 200 to the first stackable storage unit 100, the second stackable storage unit 200 is stacked on the first stackable storage unit 100, the support 140 of the second stackable storage unit 200 can push the activator 10 to rotate. The linkage mechanism 20 can be pushed by the activator 10 to rotate the cam 30. In detail, the activator 10 can rotate the first connecting rod 21, the first connecting rod 21 can slide the second connecting rod 22, the second connecting rod 22 can rotate the third connecting rod 23, the third connecting rod 23 can rotate the fourth connecting rod 24, and the fourth connecting rod 24 can rotate the cam 30. The cam 30 can accordingly slide the locking bar 50 upwardly until the locking block 51 passes through the opening 141 and each rib 52 slides out of the corresponding guiding groove 41. The torsion spring 60 can rebound to rotate the locking bar 50 substantially 90 degrees. Thus, the locking block 51 may contact the inner surface of the support 140 of the second stackable storage unit 200. Simultaneously, the spring element 70 can be elastically deformed to exert a downward force to the nut 80. In addition, the locking block 51 can accordingly move downward until abutting against the inner surface of the support 140 of the second stackable storage unit 200, thus the second stackable storage unit 200 is connected to the first stackable storage unit 100 by the connecting device 300.

When separating the second stackable storage unit 200 from the first stackable storage unit 100, the second stackable storage unit 200 is opened and the locking block 51 is rotated by a tool until rotating substantially 90 degrees, the locking block 51 can be separated from the inner surface of the support 140 of the second stackable storage unit 200. The spring element 70 can be elastically deformed to exert a downward force to the nut 80, causing the locking bar 50 to move downward. The locking bar 50 can bring the locking block 51 to move out of the support 140 of the second stackable storage unit 200 through the opening 141 until the locking bar 50 is at the position as shown in FIG. 7. Thus, the second stackable storage unit 200 can be separated from the first stackable storage unit 100. Simultaneously, the locking bar 50 can rotate the cam 30, the cam 30 can rotate the linkage mechanism 20, and the linage mechanism can rotate the activator 10 until the activator 10 is at the first position.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A connecting device comprising:
an activator whose first end is rotatably connected to a first stackable storage unit;
a linkage mechanism whose first end is rotatably connected to a second end of the activator;
a cam rotatably connected to the first stackable storage unit and rotatably connected to a second end of the linkage mechanism;
a guide attached to the first stackable storage unit and defining at least one guiding groove from an upper portion of the guide to a lower portion of the guide;
a locking bar passing from the upper portion of the guide to the lower portion of the guide and staying in contact with the circumferential surface of the cam, a top of the locking bar comprising a locking block, the locking bar further comprising at least one rib, each of the at least one rib protruding from the lateral surface of the locking bar and extending along the longitude of the locking bar, and each of the at least one rib being received in one corresponding guiding groove and sliding along the corresponding guiding groove;
a torsion spring pivoted on the locking bar, a first arm of the torsion spring being attached to the locking bar and a second arm of the torsion spring abutting against the first stackable storage unit; and
a spring element whose top end abuts against the bottom of the guide, the spring element exerting a force to the locking bar;
wherein in response to an operation of stacking a second stackable storage unit on the first stackable storage unit, the activator is pushed to rotate, the linkage mechanism is pushed by the activator to rotate the cam, the cam slides the locking bar upwardly until the locking block passes through an opening of the second stackable storage unit and each of the at least one rib slides out of the corresponding guiding groove, the torsion spring rebounds to rotate the locking bar, causing the locking block to contact the inner surface of the second stackable storage unit, the second stackable storage unit accordingly being connected to the first stackable storage unit.

2. The connecting device as described in claim 1, further comprising a nut, wherein the locking bar further comprises a thread member, the nut is threadedly connected to the thread member, and the spring element abuts against the nut.

3. The connecting device as described in claim 1, wherein the spring element is a coil spring.

4. The connecting device as described in claim 1, wherein the linkage mechanism comprises a first connecting rod, a second connecting rod, a third connecting rod, and a fourth connecting rod; a first end of the first connecting rod is connected to a bottom of the activator;
the second connecting rod is slidably connected to the first stackable storage unit, a first end of the second connecting rod is rotatably connected to a second end of the first connecting rod; the third connecting rod is rotatably connected to the first stackable storage unit, a first end of the third connecting rod is slidably and rotatably connected to a second end of the second connecting rod; and a first end of the fourth connecting rod is rotatably connected to a second end of the third connecting rod, and a second end of the fourth connecting rod is rotatably connected to the cam.

5. The connecting device as described in claim 4, wherein the second end of the second connecting rod comprises a sliding pin, the first end of the third connecting rod defines a sliding groove, and the sliding pin is slidably and rotatably received in the sliding groove.

6. A connecting device for attachably locking a first stackable storage unit to a second stackable storage unit, the connecting device comprising:
an activator with a first end and a second end, the first end of the activator rotatably connected to an outer casing of the first stackable storage unit;
a linkage mechanism with a first end and a second end, the first end of the linkage rotatably connected to the second end of the activator;
a cam rotatably connected to the outer casing and rotatably connected to the second end of the linkage mechanism;
a guide attached to the outer casing; the guide defining at least one guiding groove;
a locking bar having at least one rib extending from a body of the locking bar and extending longitudinally along the locking bar, the locking bar being slidably engaged with the guiding groove and having a first end and a second end, the first end of the locking bar in contact with, and movable by, the cam, the second end of the locking bar having a locking block;
a torsion spring positioned against the locking bar; and
a spring element positioned to exert a force on the locking bar pushing the locking block towards the guide;
wherein, when a second stackable storage unit is stacked on the first stackable storage unit, the activator is activated moving the linkage mechanism which rotates the cam, the rotation of the cam slides the locking bar toward the second stackable storage unit so that the locking block passes through an opening in the second stackable storage unit; and
wherein, when the locking block passes into the second stackable storage unit, the at least one locking bar rib slides out of the guiding groove allowing the torsion spring to rotate the locking bar so that the locking block engages the second stackable storage unit and the first stackable storage unit is attachably locked with the second stackable storage unit.

7. The connecting device as described in claim 6, further comprising a nut, wherein the locking bar has a thread number, the nut is threadedly connected to the thread member, the spring element has a top end and a bottom end, the top end of the spring element abuts against the bottom of the guide, the bottom end of the spring element abuts against the nut.

8. The connecting device as described in claim 6, wherein the spring element is a coil spring.

9. The connecting device as described in claim 6, wherein the linkage mechanism has a first connecting rod, a second connecting rod, a third connecting rod, and a fourth connecting rod; the first connecting rod, the second connecting rod, the third connecting rod, and the fourth connecting rod are rotatably connected end to end; a bottom of the activator is connected to the first connecting rod; the second connecting rod is slidably connected to the outer casing and slidably connected to the third connecting rod; the third connecting rod is rotatably connected to the outer casing; and the fourth connecting rod is rotatably connected to the cam.

10. The connecting device as described in claim 9, wherein the second connecting rod has a sliding pin, the third connecting rod defines a sliding groove, and the sliding pin is slidably and rotatably received in the sliding groove and the second connecting rod is slidably and rotatably connected to the third connecting rod.

11. A stackable storage unit comprising:
a outer casing; and
a connecting device comprising:
an activator whose first end is rotatably connected to the outer casing;
a linkage mechanism whose first end is rotatably connected to a second end of the activator;
a cam rotatably connected to the outer casing and rotatably connected to a second end of the linkage mechanism;
a guide attached to the outer casing guide and defining at least one guiding groove from an upper portion of the guide to a lower portion of the guide;
a locking bar passing from the upper portion of the guide to the lower portion of the guide and staying in contact with the circumferential surface of the cam, a top of the locking bar comprising a locking block, the locking bar further comprising at least one rib, each of the at least one rib protruding from the lateral surface of the locking bar and extending along the longitude of the locking bar, each of the at least one rib being received in one corresponding guiding groove and sliding along the corresponding guiding groove;
a torsion spring pivoted on the locking bar, a first arm of the torsion spring being attached to the locking bar and a second arm of the torsion spring abutting against the outer casing; and
a spring element whose top end abuts against the bottom of the guide, the spring element exerting a force to the locking bar;
wherein in response to an operation of stacking another stackable storage unit on the stackable storage unit, the activator is pushed to rotate, the linkage mechanism is pushed by the activator to rotate the cam, the cam slides the locking bar upwardly until the locking block passes through an opening of the another stackable storage unit and each of the at least one rib slides out of the corresponding guiding groove, the torsion spring rebounds to rotate the locking bar, causing the locking block to contact the inner surface of the another stackable storage unit, the another stackable storage unit accordingly being connected to the stackable storage unit.

12. The stackable storage unit as described in claim 11, wherein the connecting device comprises a nut, the locking bar further comprises a thread member, the nut is threadedly connected to the thread member, and the spring element abuts against the nut.

13. The stackable storage unit as described in claim 11, wherein the spring element is a coil spring.

14. The stackable storage unit as described in claim 11, wherein the linkage mechanism comprises a first connecting rod, a second connecting rod, a third connecting rod, and a fourth connecting rod; a first end of the first connecting rod is connected to a bottom of the activator; the second connecting rod is slidably connected to the outer casing, a first end of the second connecting rod is rotatably connected to a second end of the first connecting rod; the third connecting rod is rotatably connected to the outer casing, a first end of the third connecting rod is slidably and rotatably connected to a second end of the second connecting rod; and a first end of the fourth connecting rod is rotatably connected to the a second end of the third connecting rod and a second end of the fourth connecting rod is rotatably connected to the cam.

15. The stackable storage unit as described in claim 14, wherein the second end of the second connecting rod comprises a sliding pin, the first end of the third connecting rod defines a sliding groove, and the sliding pin is slidably and rotatably received in the sliding groove.

16. The stackable storage unit as described in claim 11, further comprising a beam, wherein the beam is substantially perpendicular to the outer casing and the top of the activator is rotatably connected to the beam.

17. The stackable storage unit as described in claim 11, wherein the stackable storage unit defines a first through hole, the activator is exterior to the first through hole and inclined to the stackable storage unit.

18. The stackable storage unit as described in claim 11, further comprising a guiding member, wherein the guiding member is attached to the outer casing, the guiding member defines a guiding hole, and the second connecting rod passes through the guiding hole causing the second connecting rod to be slidably connected to the stackable storage unit.
